(19) United States
(12) Patent Application Publication
(10) Pub. No.: US 2015/0016830 A1
(43) Pub. Date: Jan. 15, 2015

(54) DEVELOPER CONTAINER, DEVELOPMENT DEVICE, PROCESS CARTRIDGE, AND IMAGE FORMING APPARATUS

(71) Applicant: CANON KABUSHIKI KAISHA, Tokyo (JP)

(72) Inventors: Naoki Matsumaru, Numazu-shi (JP); Akira Suzuki, Naka-gun (JP)

(21) Appl. No.: 14/326,202

(22) Filed: Jul. 8, 2014

(30) Foreign Application Priority Data
Jul. 12, 2013 (JP) 2013-146569
Jun. 18, 2014 (JP) 2014-125611

(51) Int. Cl. G03G 15/08

(52) U.S. Cl. CPC G03G 15/0831; G03G 2215/0886
USPC 399/27

(57) ABSTRACT

A developer container includes a conductive member containing a resin configured to detect a developer amount using capacitance, and a frame member having the conductive member configured to store the developer. The conductive member is provided on a first side of the frame member contacting the developer and on a second side of the frame member, the second side is the back of the first side, and the conductive member provided on the first side and the conductive member provided on the second side are connected with each other within the frame member.

### BACKGROUND OF THE INVENTION

1. Field of the Invention

The present invention relates to a developer container, a development device, a process cartridge, and an image forming apparatus.

A development device includes a developer bearing member, and the device is used to visualize an electrostatic latent image with developer. A process cartridge includes an image bearing member for bearing the developer image and a process unit acting on the image bearing member. The image bearing member and the process unit are integrated as a cartridge.

2. Description of the Related Art

In electrophotographic image forming apparatuses using electrophotographic imaging process, a process cartridge method has been employed. In the process cartridge method, an electrophotographic photosensitive member and a process unit acting thereon are combined into one cartridge to provide the cartridge detachable from the electrophotographic image forming apparatus body.

Such a process cartridge method enables users to perform maintenance of the apparatuses by themselves without relying on service staff, and this significantly increases the apparatus operability. For this reason, the process cartridge method has been widely used in the electrophotographic image forming apparatuses.

In the electrophotographic image forming apparatuses employing the process cartridge method as described above, the users can replace the process cartridges by themselves. Consequently, the electrophotographic image forming apparatuses are often provided with a means for detecting toner consumption amount and notifying the users of the timing of replacement, that is, a toner remaining amount detection unit.

As examples of the remaining toner amount detection unit, Japanese Patent Application Laid-Open No. 2003-248371 and Japanese Patent Application Laid-Open No. 2012-168241 discuss systems for detecting change in capacitance between a plurality of electrodes disposed in a process cartridge, and notifying a remaining toner amount. In the system in Japanese Patent Application Laid-Open No. 2003-248371, a developer bearing member is used as an input side electrode, and a capacitance detection member is used as an output side electrode. The capacitance detection member is disposed to face the developer bearing member in the development device, and capacitance is detected by applying an alternating current bias to the developer bearing member. In this structure, the process cartridge is provided with a contact member for electrically connecting the capacitance detection member and a conductive member (hereinafter, referred to as a body side remaining toner amount contact) having spring properties, the conductive member being provided in the image forming apparatus body. The application of the AC bias to the developer bearing member induces an electric current corresponding to the capacitance (remaining toner amount) between the developer bearing member and the capacitance detection member. The current value is measured, through the contact member provided at the process cartridge side, and the body side toner remaining contact, by the remaining toner amount detection unit of the image forming apparatus body and thereby the remaining toner amount can be sequentially detected.

### SUMMARY OF THE INVENTION

The present invention has been made by further improving the above-described techniques, and provides a simple structure for capacitance detection provided, for example, in a process cartridge.

According to an aspect of the present invention, a developer container includes a conductive member containing a resin, the conductive member being configured to detect a developer amount using capacitance, and a frame member having the conductive member configured to store the developer. The conductive member is provided on a first side of the frame member contacting the developer and on a second side of the frame member, the second side is the back of the first side, and the conductive member provided on the first side and the conductive member provided on the second side are connected with each other within the frame member.

According to another aspect of the present invention, a developer container includes a conductive member containing a resin, the conductive member being configured to detect a developer amount using capacitance, and a frame member having the conductive member configured to store the developer. The frame member includes a curved surface or a bent portion, and the conductive member is provided on the curved surface or the bent portion. Further, a development device, a process cartridge, and an image forming apparatus are provided.

As described above, according to the exemplary embodiments of the present invention, a developer container and a process cartridge having simple structures to detect capacitance can be provided.

Further features of the present invention will become apparent from the following description of exemplary embodiments with reference to the attached drawings.

### BRIEF DESCRIPTION OF THE DRAWINGS

FIG. 1 is a cross-sectional view illustrating a development device inserted into an apparatus body.

FIG. 2 is a cross-sectional view illustrating an image forming apparatus according to the first exemplary embodiment.

FIG. 3 is a cross-sectional view illustrating a process cartridge according to the first exemplary embodiment.

FIG. 4 is a perspective view illustrating the image forming apparatus body with an opened opening/closing door and the process cartridge according to the first exemplary embodiment.

FIG. 5 is a perspective view illustrating a structure of the process cartridge according to the first exemplary embodiment.

FIG. 6 is a partial perspective view of a member formed by a conductive sheet serving as the remaining toner amount detection member to constitute a cover member serving as a first frame member.

FIGS. 7A to 7E are conceptual views of a mold structure according to the first exemplary embodiment.

FIGS. 8A to 8C are cross-sectional views illustrating the conductive sheet according to the exemplary embodiment of the present invention.

FIGS. 9A to 9E are conceptual views of a mold structure according to the first exemplary embodiment.

FIG. 10 is a cross-sectional view illustrating the cover member having the conductive sheet according to the exemplary embodiment of the present invention.

FIGS. 11A to 11C are conceptual views illustrating a mold structure of a conductive sheet contact portion according to the exemplary embodiment of the present invention.

FIG. 12 is a partial perspective view illustrating the coupling of the cover member having the integrally molded conductive sheet, and a toner storage container frame member according to the first exemplary embodiment.

FIG. 13 is a perspective view illustrating a development device to which the exemplary embodiment of the present invention can be applied.

FIG. 14 is a partial perspective view illustrating a cover member having a conductive sheet according to the second exemplary embodiment.

FIG. 15 is a partial cross-sectional view illustrating the cover member having the conductive sheet according to the second exemplary embodiment.

FIGS. 16A and 16B are schematic views illustrating a structure of a mold for a contact portion of the conductive sheet according to the second exemplary embodiment.

FIG. 17 is a cross-sectional view illustrating the cover member having the conductive sheet, and further having a toner storage container welded to the cover member.

FIGS. 18A and 18B illustrate a layout of the contact portion of the conductive sheet according to the first exemplary embodiment.

FIG. 19 is a cross-sectional view illustrating a portion around the contact portion of the conductive sheet in a state where the cartridge is inserted into the apparatus body according to the first exemplary embodiment.

FIG. 20 is a cross-sectional view illustrating the conductive sheet according to the first exemplary embodiment.

FIGS. 21A and 21B illustrate a layout of the contact portion of the conductive sheet according to the first exemplary embodiment.

### DESCRIPTION OF THE EMBODIMENTS

Various exemplary embodiments, features, and aspects of the invention will be described in detail below with reference to the drawings.

Hereinafter, the first exemplary embodiment of the present invention is described in detail with reference to the attached drawings.

A rotational axis direction of an electrophotographic photosensitive drum serving as an image bearing member is the longitudinal direction. In the longitudinal direction, the side where the electrographic photosensitive drum receives driving force from the image forming apparatus body is defined as a driven side, and the other side is defined as a non-driven side.

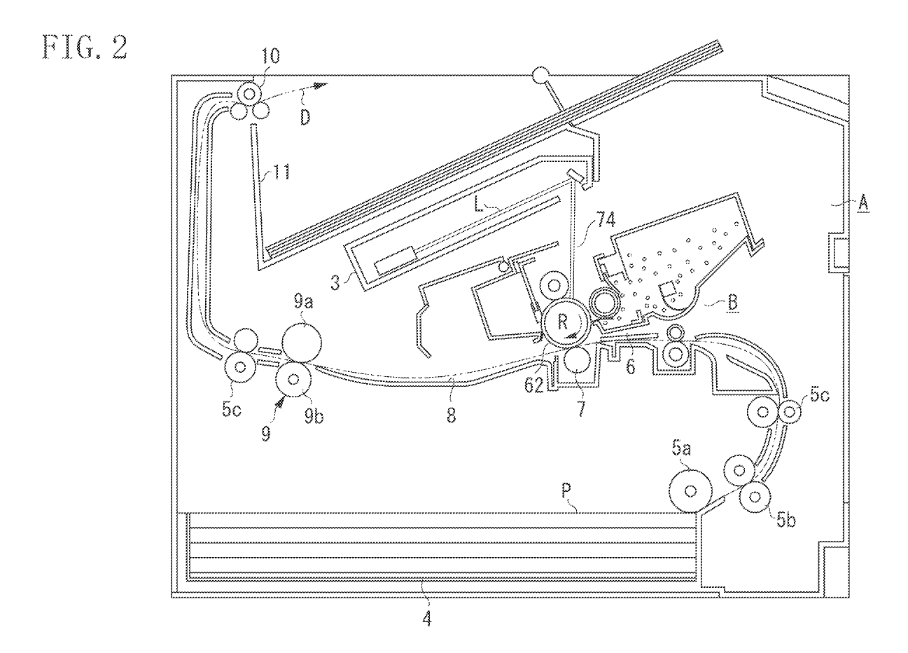

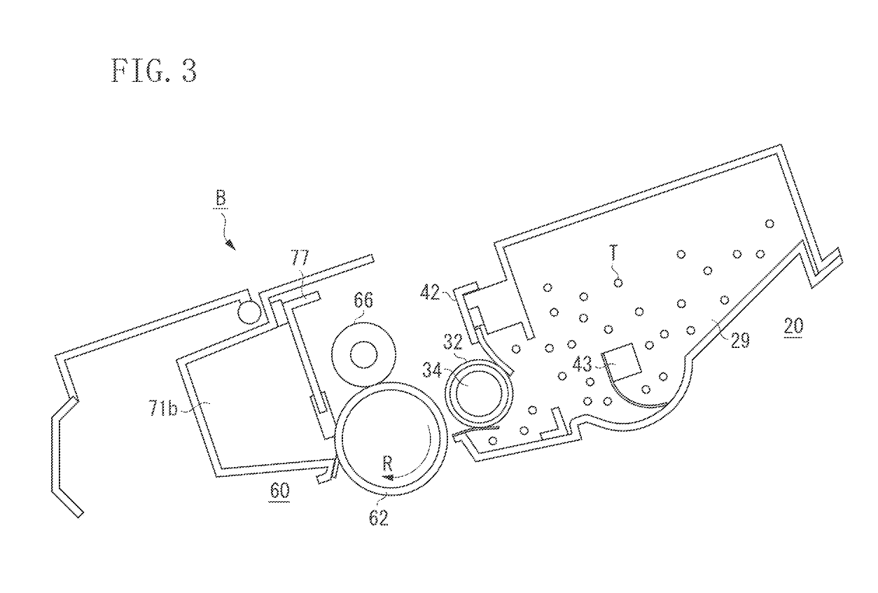

With reference to FIGS. 2 and 3, the overall structure and an image forming process are described.

FIG. 2 is a cross-sectional view illustrating an image forming apparatus body (hereinafter, referred to as an apparatus body A) of an electrophotographic image forming apparatus and a process cartridge (hereinafter, referred to as a cartridge B) according to the exemplary embodiment of the present invention. FIG. 3 is a cross-sectional view of the cartridge B.

The apparatus body A of the electrophotographic image forming apparatus is an electrophotographic image forming apparatus portion except for the cartridge B.

### (Overall Structure of the Image Forming Apparatus)

In FIG. 2, the electrophotographic image forming apparatus is a laser beam printer employing an electrophotographic technique enabling attachment/detachment of the cartridge B to/from the apparatus body A. In a state where the cartridge B is set to the apparatus body A, an exposure device 3 (laser scanner unit) is disposed over the cartridge B.

Blow the cartridge B, a sheet tray 4 that stores a recording medium (hereinafter, referred to as a sheet material P) such as paper on which an image is formed is disposed.

Further, the apparatus body A includes serially along the conveyance direction D of the sheet material P, a pickup roller 5a, a sheet feeding roller pair 5b, a conveyance roller pair 5c, a transfer guide 6, a transfer roller 7, a conveyance guide 8, a fixing device 9, a discharge roller pair 10, and a discharge tray 11 in this order. The fixing device 9 includes a heating roller 9a and a pressure roller 9b.

### (Image Forming Process)

The image forming process is briefly described. In response to a print start signal, an electrophotographic photosensitive drum (hereinafter, referred to as a drum 62) serving as an image bearing member is rotated to drive at a predetermined circumferential velocity (process speed) in the arrow R direction.

A charging roller 66 serving as a charging means to which a bias voltage is applied contacts the outer circumferential surface of the drum 62 to uniformly charge the outer circumferential surface of the drum 62. The exposure device 3 outputs a laser beam L according to image information. The laser beam L passes through an exposure window portion 74 of the top surface of the cartridge B to scan and expose the outer circumferential surface of the drum 62. Thus, an electrostatic latent image corresponding to the image information is formed on the outer circumferential surface of the drum 62.

Meanwhile, as illustrated in FIG. 3, in a development device unit 20, toner T in a toner storage portion 29 is stirred and conveyed by the rotation of a conveyance member 43.

The toner T is carried onto the surface of a development roller 32 by the magnetic force of a magnet roller (stationary magnet) 34. The thickness of the toner T layer on the circumferential surface of the development roller 32 is controlled by a development blade 42 serving as a developer layer thickness regulation member while being friction-charged.

The toner T is transferred corresponding to the electrostatic latent image to the drum 62, and visualized as a toner image (developer image).

As illustrated in FIG. 2, at the timing of output of the laser beam L, the pickup roller 5a, the sheet feeding roller pair 5b, and the conveyance roller pair 5c feed the sheet material P stored in the lower part of the apparatus body A from the sheet tray 4.

The sheet material P is conveyed via the transfer guide 6 to a transfer position between the drum 62 and the transfer roller 7. At the transfer position, the toner image is sequentially transferred from the drum 62 onto the sheet material P.

The sheet material P on which the toner image has been transferred is separated from the drum 62 and conveyed to the fixing device 9 along the conveyance guide 8. Then, the sheet material P passes through the nip portion of the heating roller 9a and the pressure roller 9b of the fixing device 9.

At the nip portion, heating-fixing processing is performed and the toner image is fixed onto the sheet material P. The sheet material P onto which the toner image fixation process has been made is conveyed to a discharge roller pair 10, and discharged onto a discharge tray 11.

Meanwhile, as illustrated in FIG. 3, the toner remaining on the outer circumferential surface of the transfer-processed drum 62 is removed by a cleaning blade 77. The drum 62 is used again in the image forming process. The toner removed from the drum 62 is stored in a waste toner chamber 71b in a cleaning unit 60.

In this exemplary embodiment, the charging roller 66 serving as a charging unit, the development roller 32 serving as a developer bearing member, and the cleaning blade 77 serving as a cleaning unit constitute a process unit acting on the drum 62. The process unit may include at least one of the charging unit, the development unit, and the cleaning unit.

### (Attachment and Detachment Structure of the Cartridge)

With reference to FIG. 4, the attachment/detachment of the cartridge B to/from the apparatus body A is described.

FIG. 4 is a perspective view of the apparatus body A with an opening/closing door 13 opened for attachment or detachment of the cartridge B, and the cartridge B.

To the apparatus body A, the opening/closing door 13 is rotatably mounted. When the opening/closing door 13 is opened, a guide rail 12 provided within the apparatus body A appears, and the cartridge B is installed into the apparatus body A along the guide rail 12.

A driven shaft 14 to be driven by a motor (not illustrated) of the apparatus body A engages with a driving force reception unit provided in the cartridge B.

With this structure, the drum 62 engaging with the driving force reception unit receives the driving force from the apparatus body A and rotates.

### (Overall Structure of the Cartridge)

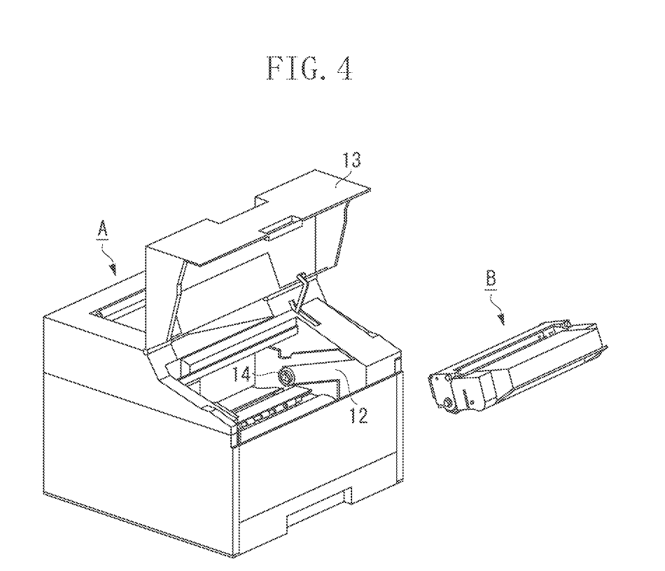

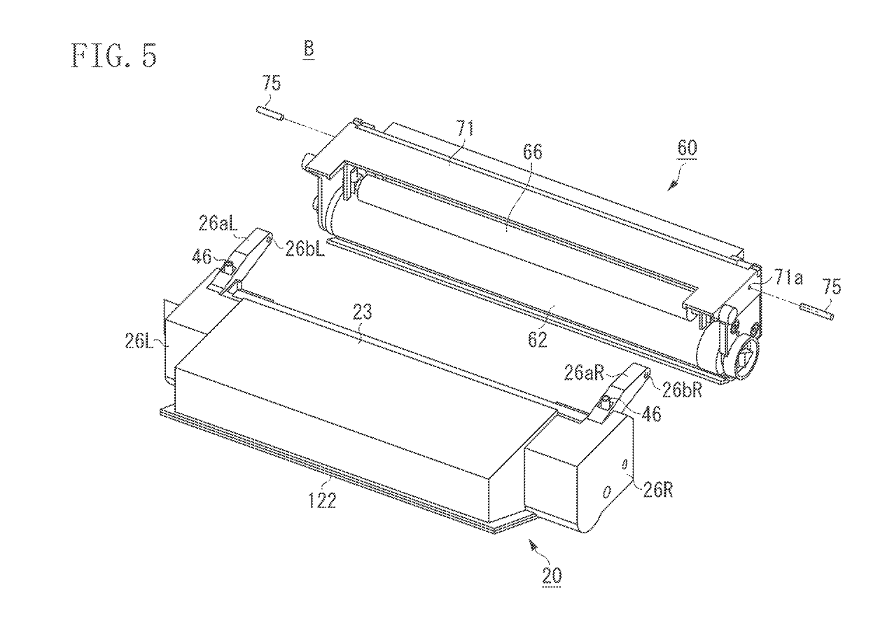

With reference to FIGS. 3 and 5, an overall structure of the cartridge B is described.

FIG. 5 is a perspective view illustrating a structure of the cartridge B.

The cartridge B is formed by integrating the cleaning unit 60 and the development device unit 20.

The cleaning unit 60 includes a cleaning frame member 71, the drum 62, the charging roller 66, and the cleaning blade 77.

The development device unit 20 includes a cover member 122, a toner storage container 23, a first side member 26L, a second side member 26R, the development blade 42, the development roller 32, the magnet roller 34, a conveyance member 43, the toner T, and an urging member 46.

The cartridge B is formed by rotatably connecting the cleaning unit 60 with the development device unit 20 by connection members 75.

Specifically, rotation holes 26bL and 26bR are provided in parallel with the development roller 32 at end portions of arm units 26aL and 26aR formed in the first side member 26L and the second side member 26R at both end portions of the development device unit 20 in the longitudinal direction.

At the both end portions of the cleaning frame member 71 in the longitudinal direction, fitting holes 71a for the connection members 75 to fit into are formed.

The arm units 26aL and 26aR are positioned at predetermined positions on the cleaning frame member 71, and the connection members 75 are inserted into the rotation holes 26bL and 26bR and the fitting holes 71a. With this structure, the cleaning unit 60 and the development device unit 20 are rotatably connected around the connection members 75, and thereby the process cartridge is formed.

In this structure, the urging members 46 attached at the bottom of the arm unit 26aL and 26aR contact the cleaning frame member 71, and urge the development device unit 20 against the cleaning unit 60 around the connection members 75 serving as the rotation center. With this structure, the development roller 32 is surely pressed in the direction toward the drum 62.

### (Development Device Unit)

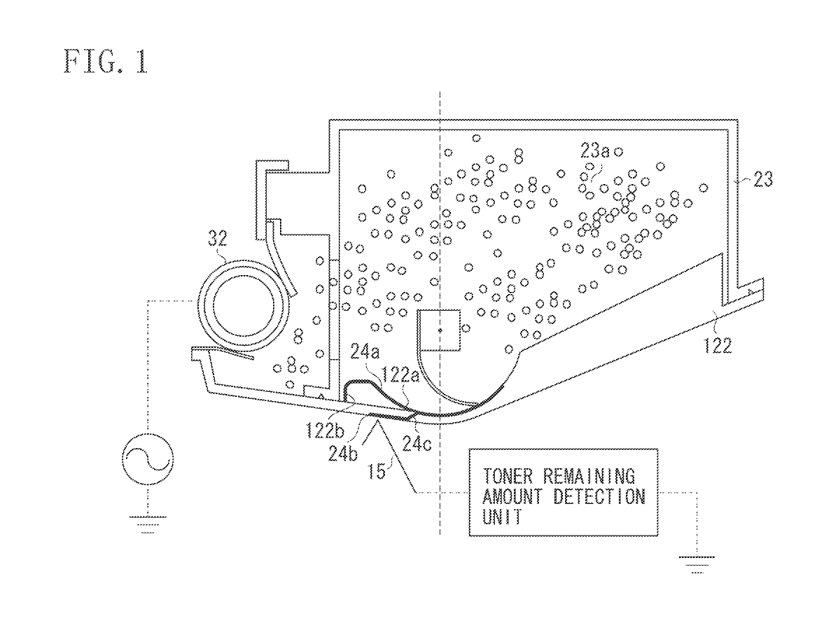

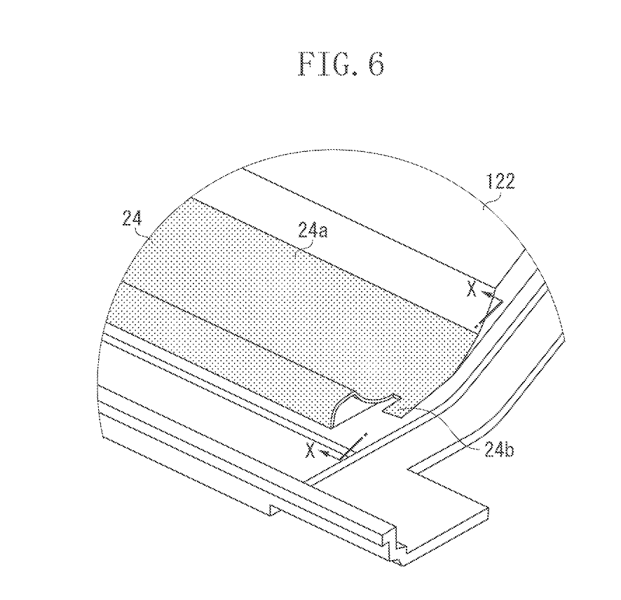

With reference to FIG. 1 and FIGS. 6 to 12, a structure of the development device unit 20 according to the exemplary embodiment of the present invention is described. FIG. 6 is a partial perspective view of a member formed by integrating a conductive sheet 24, which is a conductive member serving as a remaining toner amount detection member, with the cover member 122 serving as a first frame member.

As illustrated in FIG. 1 and FIG. 6, the conductive sheet 24, which is a conductive member, has two functional portions. One portion is a remaining toner amount detection portion 24a to be used to detect a developer amount. The other portion is a contact portion 24b to be used to electrically connect to an external part such as the apparatus body. A part of the conductive member functions as the remaining toner amount detection portion 24a, and the other part of the conductive member functions as the contact portion 24b to be electrically connected to an external part. The entire conductive sheet 24, which is the conductive member, is integrated with the cover member 122. In this exemplary embodiment, the contact portion is a portion exposed to the outer surface in the conductive sheet. The surface area of the contact portion is an area being exposed to the outer surface.

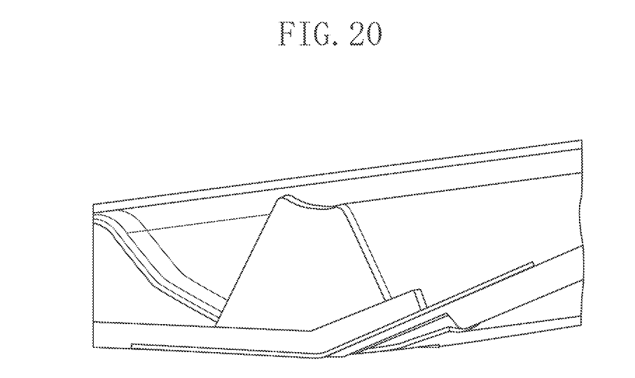

As illustrated in FIG. 1, the conductive member is formed on a curved surface portion 122a and a bent portion 122b of the cover member 122, which is the frame body. This is because a resin contained in the conductive member makes the shape of the conductive member flexible. As will be understood from FIG. 1, the conductive sheet is formed starting from the curved surface of the curved surface portion, which connects to a plane portion, and advancing from the plane, via the bent portion, along the wall surface formed in the direction of gravity, to constitute the conductive member. When viewed along the rotation shaft of the development roller (cross section), the conductive sheet is disposed across the rotation shaft of the stirring member. This is because the conductive sheet is provided in the wide area to detect a remaining toner amount in a wide area. A joint portion 24c connecting the remaining toner amount detection portion 24a and the contact portion 24b that are parts of the conductive sheet is formed from the curved surface portion of the inner surface of the frame member toward the outside surface. From a manufacturing point of view, as compared to the method of forming the joint portion 24c of the conductive member from the curved surface portion as illustrated in FIG. 1, it is easier to form the joint portion of the conductive member on the straight plane as illustrated in FIG. 20. In such a case, it is easier to manufacture the joint portion if the plane of the conductive sheet more distant from the development roller than the rotation shaft of the stirring member in FIG. 1 is also flat since the plane is continuously flat.

More specifically, in this structure, the bent portion is an area including the top of the convex portion projecting toward the development roller. The curved surface portion and the bent portion constitute a part of the convex portion projecting from the cover member. As will be understood from FIG. 6, the convex portion extends in the same direction as the longitudinal direction of the conductive sheet. In FIG. 1, the convex portion is in the storage chamber storing the toner, and the convex portion is connected to the development chamber having the development roller via an opening. In the cross section viewed along the rotation shaft of the stirring member, a development sleeve 32, the opening, the convex portion, and the rotation shaft of the stirring member are disposed in this order in the horizontal direction.

Meanwhile, as illustrated in FIGS. 1 and 6, one conductive sheet can be used as an electrode for detecting capacitance. Alternatively, a plurality of conductive sheets can be disposed. For example, in FIG. 1, one conductive sheet is formed on the bent portion, and another conductive sheet can be provided at a position more distant from the development roller than the rotation shaft of the stirring member. In such a case, the contact points can be separately formed. Forming the conductive sheet on the bent portion enables detection of a change in the toner amount near the development roller as an electrical signal. Consequently, when the remaining toner amount becomes low, the remaining toner amount can be correctly detected. The conductive sheet provided at the position more distant from the development roller than the rotation shaft of the stirring member is used to detect a rough remaining toner amount. With the plurality of conductive sheets, the remaining amount can be more correctly detected by comparing the electrical signals such as voltage detected from the electrodes and obtaining the difference.

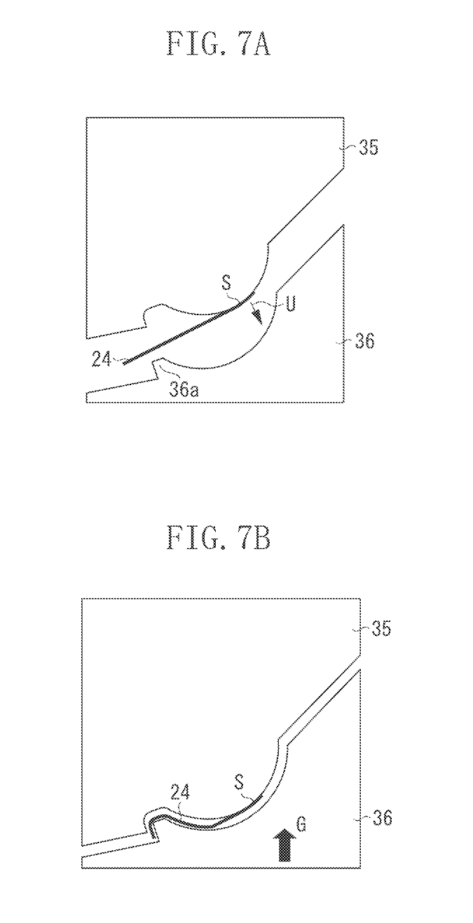

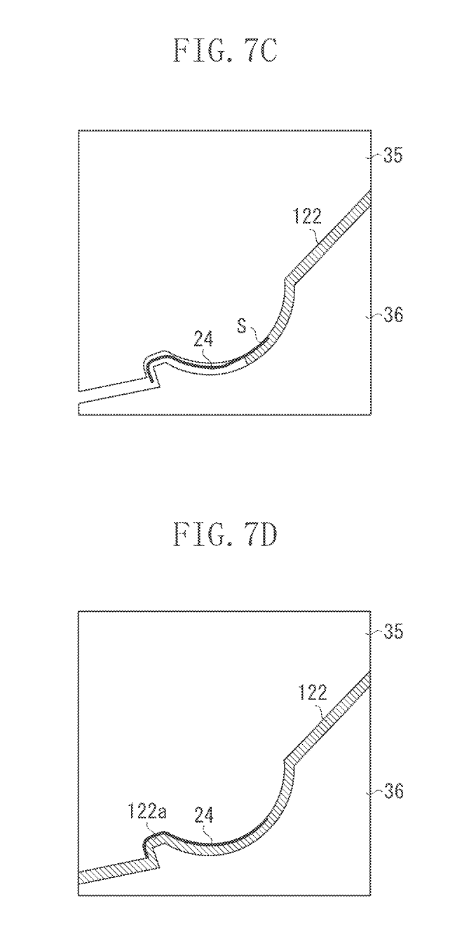

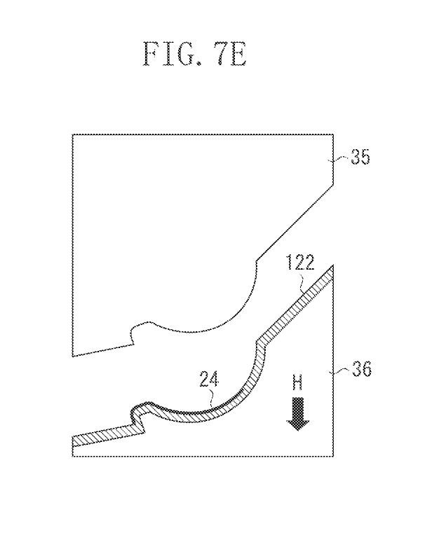

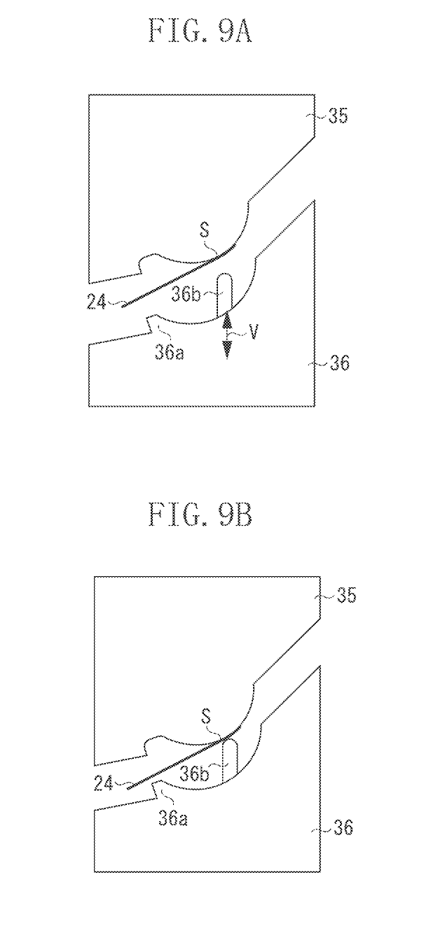

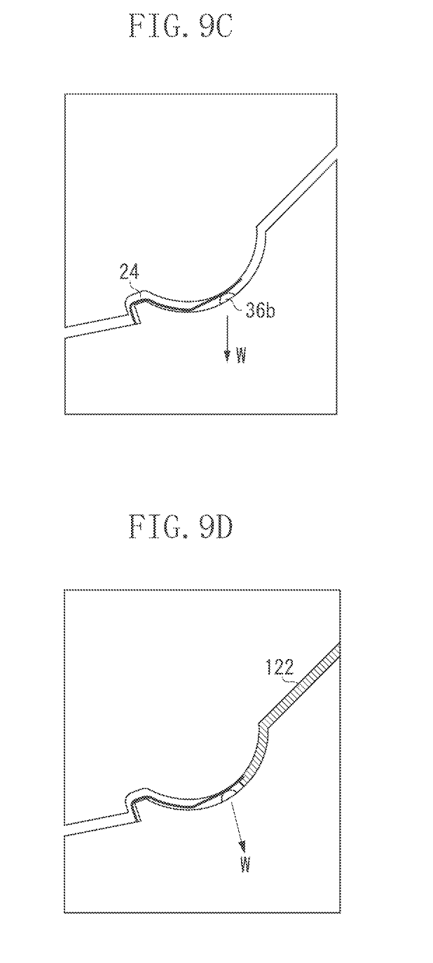

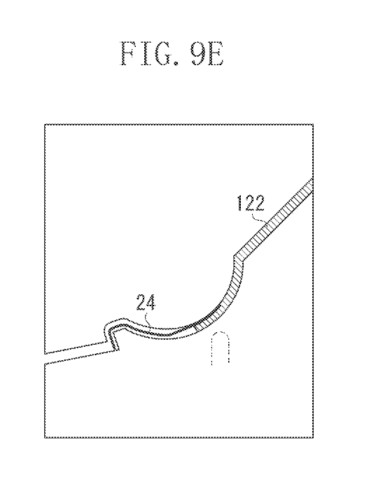

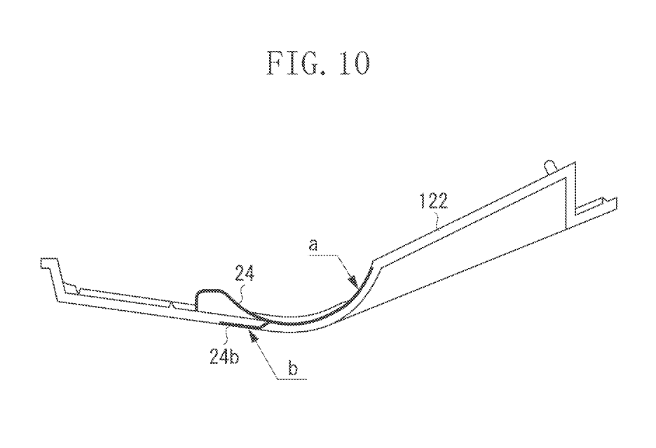

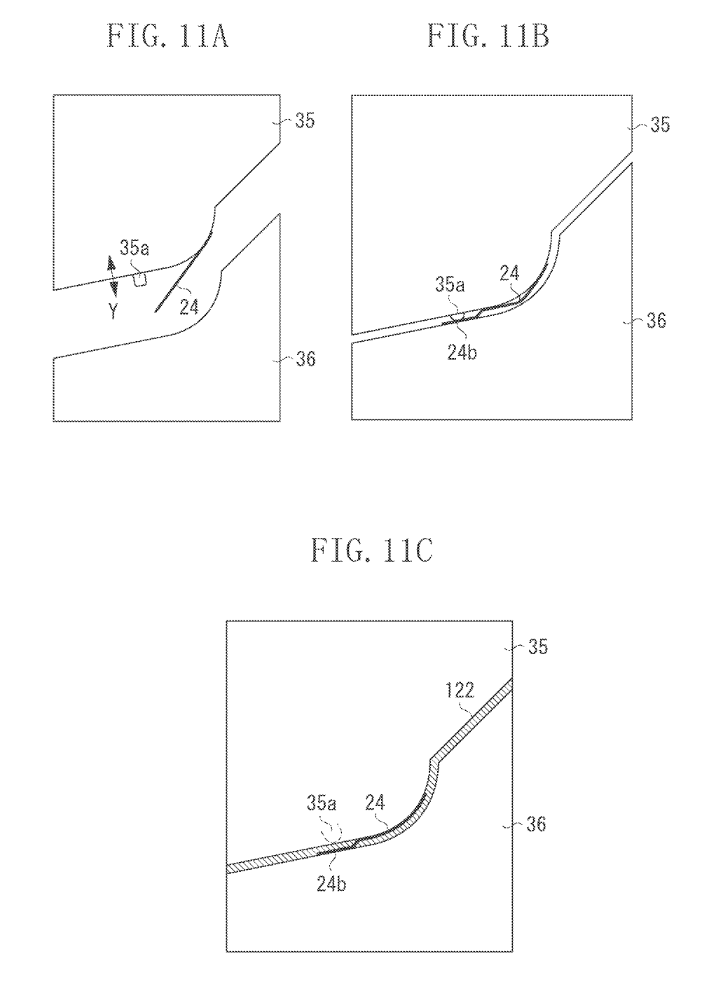

Hereinafter, a method of manufacturing the developer container is described. Important factors in manufacturing the developer container include integrated molding (in this exemplary embodiment, sheet molding) of the conductive sheet and the cover member. In this exemplary embodiment, prior to the description of the integrated molding of the conductive sheet 24 to the cover member 122, first, an integrated molding method for the remaining toner amount detection portion 24a is described with reference to FIGS. 7 and 9. Then, an integrated molding method for the contact portion 24b according to the exemplary embodiment of the present invention is described with reference to FIGS. 10 and 11.

FIGS. 7A to 7E are conceptual views illustrating a mold structure used in this exemplary embodiment. In this exemplary embodiment, a fine air hole is provided in an area S of a mold 35 of a fixed side. The fine air hole is connected to a suction device (not illustrated) to fix the conductive sheet 24 to the mold 35 at the fixed side.

When the conductive sheet 24 is sucked and held in the mold at the fixed side, a movable side 36 of the mold moves in the G direction and becomes the state shown in FIG. 7B.

Then, a resin which is a material for the cover member 122 is injected (the shaded area in FIG. 7C) from a gate portion (not illustrated). As illustrated in FIG. 7C to 7D, by the injection pressure of the resin, the surface of the conductive sheet 24 is molded in the shape of the mold 35 of the fixed side. When the injection of the resin is completed (FIG. 7D), the suction of the conductive sheet 24 by the mold 35 of the fixed side is stopped. Then, the mold 36 of the movable side opens in the H direction, and the integrated molding of the conductive sheet 24 to the cover member 122 is completed (FIG. 7E).

In this exemplary embodiment, to the fixed side 35 in the mold, the conductive sheet 24 is held and fixed. This is because after the completion of the injection of the resin, while the movable side 36 of the mold is open (FIG. 7E), the next conductive sheet 24 can be set (held and fixed) to the fixed side 35 of the mold to shorten the molding cycle. Consequently, it is not always necessary to fix the conductive sheet 24 to the fixed side 35 of the mold, and the conductive sheet 24 can be fixed to the movable side 36 of the mold.

In this exemplary embodiment, the conductive sheet is formed by the integrated molding. Alternatively, the conductive sheet can be formed, for example, by gluing resins together.

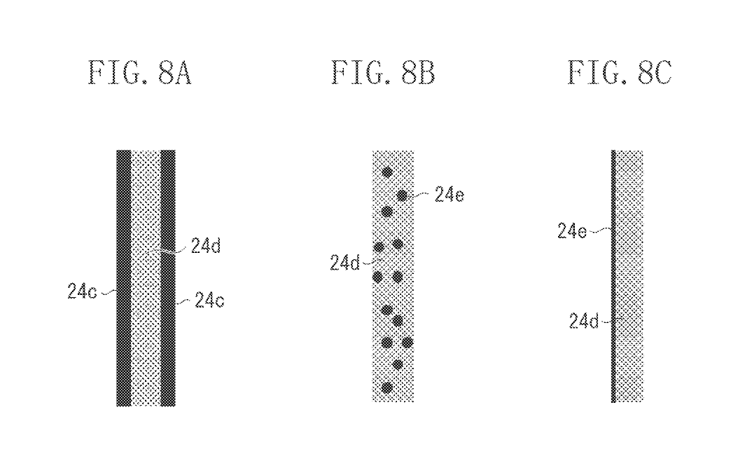

FIGS. 8A to 8C are cross-sectional views illustrating the conductive sheet 24 used in this exemplary embodiment. FIG. 8A illustrates a three-layered conductive sheet sandwiching polystyrene (PS) resin 24d between conductive layers 24c (20 μm to 40 μm) formed by mixing carbon black in the PS resin. FIG. 8B illustrates a one-layer conductive sheet formed by mixing a carbon black 24e into the ethylene-vinyl acetate (EVA) resin 24d. FIG. 8C illustrates a two-layered conductive sheet formed by printing the carbon black 24e on the PS resin 24d. The conductive sheet 24 having an overall thickness of approximately t=0.05 to 0.3 mm is used. As an alternative to the carbon black, for example, the other carbon material such as graphite and carbon fiber can be used. Alternatively, without using the carbon material, the conductive sheet can be formed using a conductive resin. For example, the conductive sheet can be formed by a method of doping with an electron receptor (acceptor) such as iodine and arsenic pentafluoride, or an electron donor (donor) such as alkali metal to provide conductivity.

With respect to the conductive sheet 24, as an alternative to the above-described materials, a material can be used that can fit in the mold by resin pressure to form the conductive sheet 24, and after the molding, can be fixed to the cover member 122 at a predetermined strength or greater.

The fixation of the conductive sheet 24 to the mold can be made by suction as described above. Alternatively, a pin for fixing the conductive sheet 24 to the mold can be provided, or both of the suction and the pin can be used.

For example, with a mold illustrated in FIGS. 9A to 9E, the conductive sheet 24 can be integrated to the cover member 122. By this method, a retaining pin 36b that can move in the V direction in FIG. 9A is added to the mold at the movable side. In the process (FIG. 9B) of closing the mold, before a portion 36a of the mold of the movable side contacts the conductive sheet 24, the retaining pin 36b that is formed as a protrusion can fix the conductive sheet 24 to the mold 35. That is, the conductive sheet is pressed and deformed by the protrusion, which is the retaining pin 36b in the mold, and fixed to the mold of the movable side.

FIG. 9C illustrates a state where the mold is closed in the above-described structure. The retaining pin 36b can be moved in the W direction when it receives the resin pressure. Such a shape can prevent the cavity of the retaining pin 36b from remaining on the cover member 122 (i.e., the concaved portion does not remain) (FIGS. 9D and 9E).

With reference to FIGS. 10 and 11, the contact portion 24b of the conductive sheet according to the exemplary embodiment of the present invention is described.

FIG. 10 is a cross-sectional view taken along the line X-X in FIG. 6. As illustrated in the drawing, the contact portion 24b of the conductive sheet 24 is molded to be exposed to a surface B that is the back side of a surface A of the cover member 122. On the surface A, the conductive sheet 24 contacts the toner. The side contacting the toner is the side where a space capable of containing the toner is formed by connecting the cover member that is a first frame member and the toner storage container that is a second frame member. That is, the conductive sheet is also formed also on a surface opposite to the surface contacting the toner (developer), that is, on the surface of the other side. At the end portion of the surface contacting the toner, the conductive sheet has a long and thin portion. A part of the conductive sheet extends in the direction (more specifically, in the perpendicular direction) intersecting with the longitudinal direction of the conductive sheet. The joint portion extending in the direction perpendicular to the longitudinal direction of the conductive sheet has a shape extending into the cover member that is the frame member while extending in the intersecting direction. The joint portion of the conductive sheet extending into the inner part of the cover member that is the frame member is connected to the contact portion that is a part of the conductive sheet of the opposite side.

FIGS. 11A to 11C are schematic views illustrating a mold for forming the contact portion 24b of the conductive sheet. In this exemplary embodiment, to surely press the contact portion 24b of the conductive sheet 24 against the mold of movable side, a retaining pin 35a is provided at the fixed side 35 of the mold (FIG. 11A). The retaining pin 35a is disposed such that the retaining pin 35a can move in the Y direction. When the mold is closed, by a spring force (not illustrated), the contact portion 24b of the conductive sheet 24 is fixed to the mold 36 of the movable side (FIG. 11B). When the molding is closed, a resin is injected (FIG. 11C), and the retaining pin 35a retracts by the resin pressure. With this structure, the contact portion 24b of the conductive sheet 24 can be formed to be exposed to the side B of the back side. In other words, the contact portion 24b is formed such that, within the frame member, a part of the conductive sheet provided on the first side that contacts the toner, is connected to a part of the conductive sheet provided at the back side that is a second side. It is preferable that the connecting part within the first frame of the conductive sheet contains a resin, and more preferably, the part contains a conductive carbon material and a resin. Instead of the carbon material, a conductive resin may also be contained.

A surface area of the contact portion 24b is smaller than the surface area of the conductive sheet portion provided on the first side.

In this exemplary embodiment, as described above, to surely press the contact portion 24b of the conductive sheet 24 against the mold of the movable side, the retaining pin 35a having the spring force at the fixed side of the mold is disposed. In another structure, a slide piece portion (not illustrated) can be provided at the fixed side of the mold, and the slide piece portion can be moved by a driving unit such as a cylinder. With the structure, the contact portion 24b of the conductive sheet 24 can be surely pressed against the mold of the movable side. When the mold is closed, the slide piece portion is pressed against the mold of the movable side through the conductive sheet 24, and the resin is injected. When the resin is injected to a part around the contact portion 24b of the conductive sheet 24, the slide piece portion is retracted from the mold of the movable side, and the resin is also injected to the space from which the slide piece portion has retracted. As described above, with the structure the slide piece portion is moved, a mold can also be formed by exposing the contact portion 24b of the conductive sheet 24 to the surface B of the back side.

In the above description, the retaining pin 35a and the slide piece portion is structured such that they retract after the injection of the resin, and the resin is injected into the retracted space. Alternatively, a structure in which the retaining pin 35a and the slide piece portion do not retract can be used. In such a case, into the portions of the retaining pin 35a and the slide piece portion which press the conductive sheet 24 against the mold of the movable side, the resin is not injected. However, formation of a space such as a hole in the cover member 122 to which the conductive sheet 24 has been integrated can be prevented by providing the conductive sheet 24 wider than the portion where the conductive sheet 24 is being pressed against the mold of the movable side with the retaining pin 35a and the slide piece portion.

With reference to FIGS. 1, 12, and 13, a remaining toner amount detection system is described.

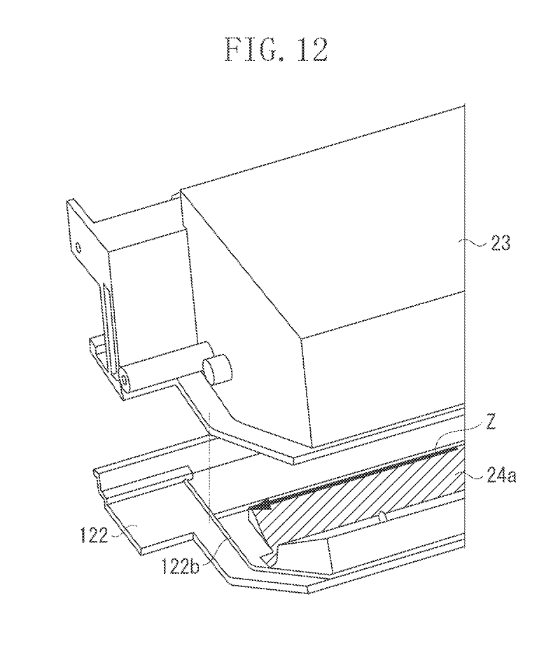

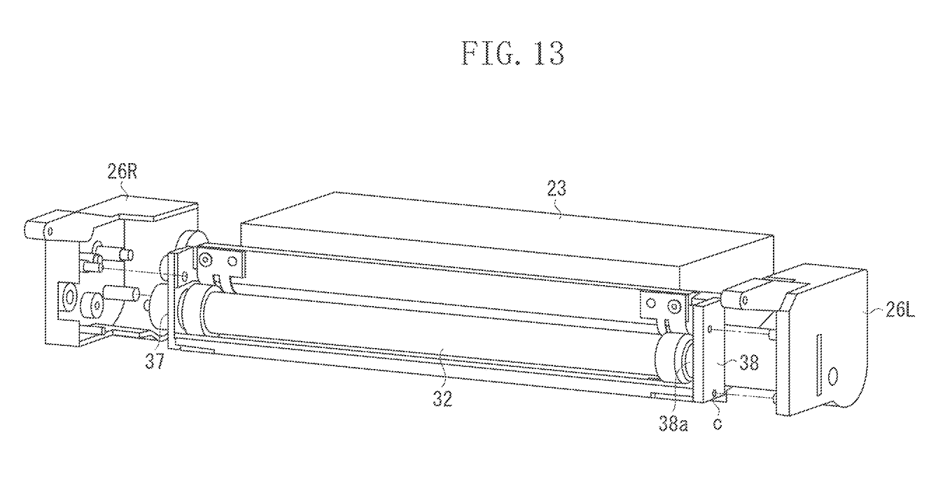

As described above, the cover member 122 having the integrally formed conductive sheet 24 is fixed to the toner storage container 23 by means of welding, or the like as illustrated in FIG. 12. In this exemplary embodiment, a welding rib 122b is provided in the cover member 122, and ultrasonic vibration is applied to join the cover member 122 and the toner storage container 23 to form the developer container.

In this exemplary embodiment, a width Z (FIG. 12) in the longitudinal direction of the remaining toner amount detection portion 24a of the conductive sheet 24 is limited, within the toner storage container 23, to a range in which change in the capacitance generated by change in the remaining toner amount can be detected. The contact portion 24b of the conductive sheet 24 is provided at the non-driven side in the longitudinal direction. If the contact portion 24b is provided at the driven side, between the contact portion 24b and an electrical contact for drive, parasitic capacitance can be generated.

As illustrated in FIG. 13, the development roller 32 that is a developer bearing member having conductivity is disposed to face the conductive sheet 24. The development roller 32, is supported by bearing members 37 and 38 and rotatably attached to the toner storage container 23 through the side members 26L and 26R.

In this exemplary embodiment, as a material for the development roller 32, hollow aluminum is used, and for the bearing member 38 on the non-driven side, a conductive resin is used. The inner circumference of the non-driven side of the development roller 32 is supported by the outer circumference 38a of the bearing member 38.

In response to insertion of the cartridge B into the apparatus body A, a development contact spring (not illustrated) electrically connected to a circuit in the apparatus body A comes in contact with a lower surface C (FIG. 13) of the bearing member 38 and thereby a bias is applied to the development roller 32.

FIG. 1 is a cross-sectional view illustrating the development device 20 having the cartridge B inserted into the apparatus body A. When the cartridge B is inserted into the apparatus body A, the contact portion 24b of the conductive sheet 24 comes in contact with the remaining toner amount contact 15 of the apparatus body side. The remaining toner amount contact 15 is electrically connected to the remaining toner amount detection unit of the apparatus body A.

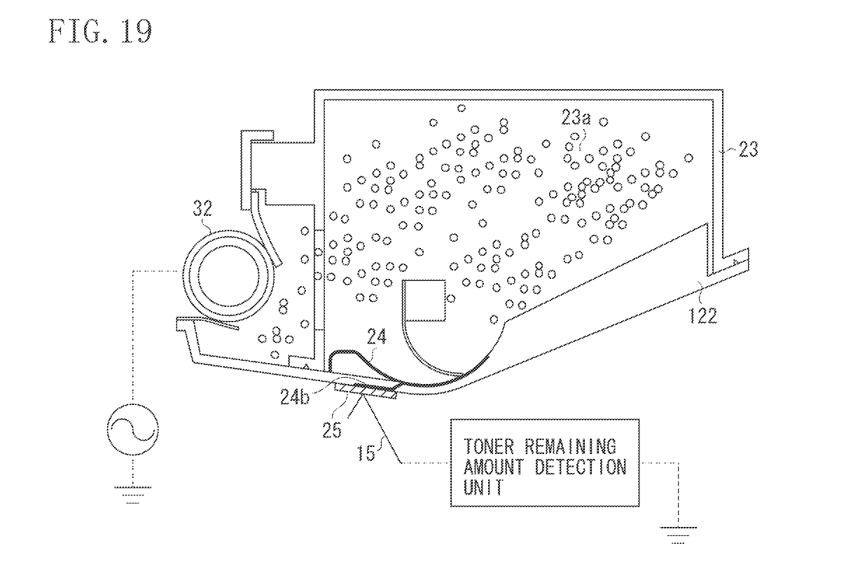

In this exemplary embodiment, the contact portion 24b of the conductive sheet 24 is provided abutting on the remaining toner amount contact 15 of the apparatus body A. In another structure, as illustrated in FIG. 19, a contact member 25 can be provided between the contact portion 24b of the conductive sheet 24 and the remaining toner amount contact portion 15 of the apparatus body A. FIG. 19 is a cross-sectional view around the contact portion 24b of the development device 24 having the cartridge B inserted into the apparatus body A. As a material for the contact member 25, a metal material or a conductive resin member can be used. For example, the contact portion 24b of the conductive sheet 24 is inserted into the remaining toner amount contact 15 of the apparatus body A while rubbing against each other. Such a structure prevents the contact portion 24b from being shaved and enables stable electrical connection.

Application of alternating current (AC) voltage to the development roller 32 induces current corresponding to capacitance between the development roller 32 and the conductive sheet 24. The capacitance changes depending on an amount of the toner T between the development roller 32 and the conductive sheet 24. Consequently, through the remaining toner amount contact 15 of the apparatus body side, the induced current value is measured by the remaining toner amount detection unit, and thereby the remaining toner amount T between the development roller 32 and the conductive sheet 24 can be sequentially detected.

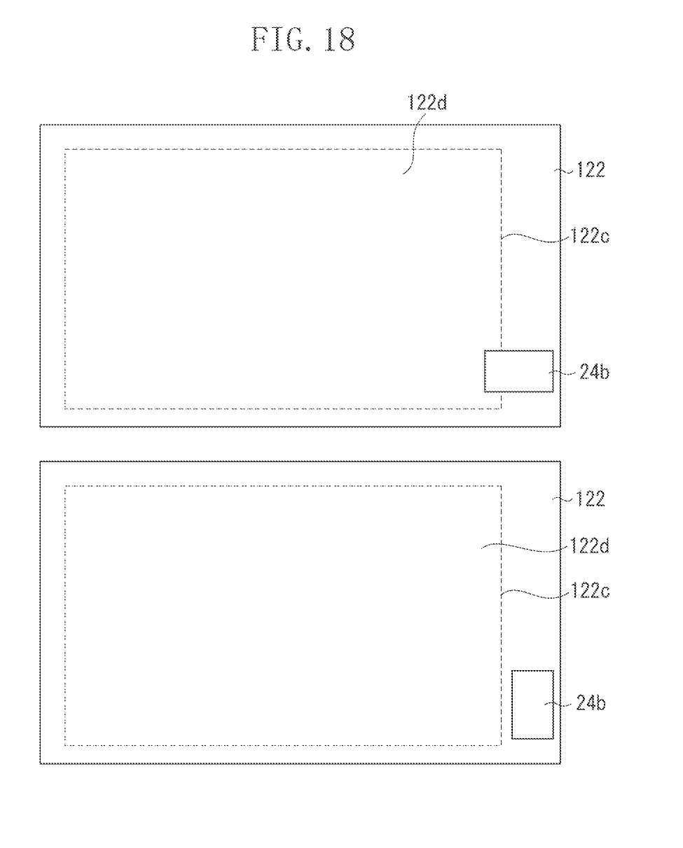

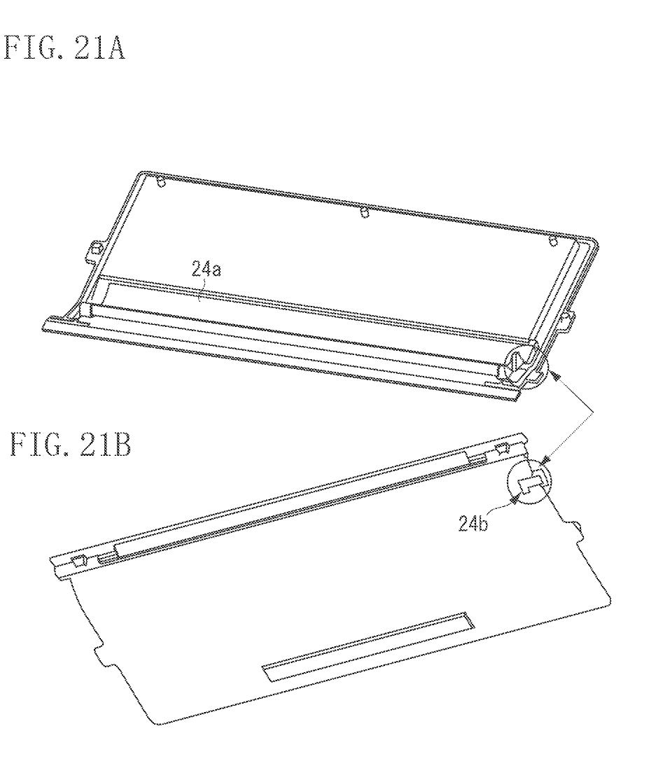

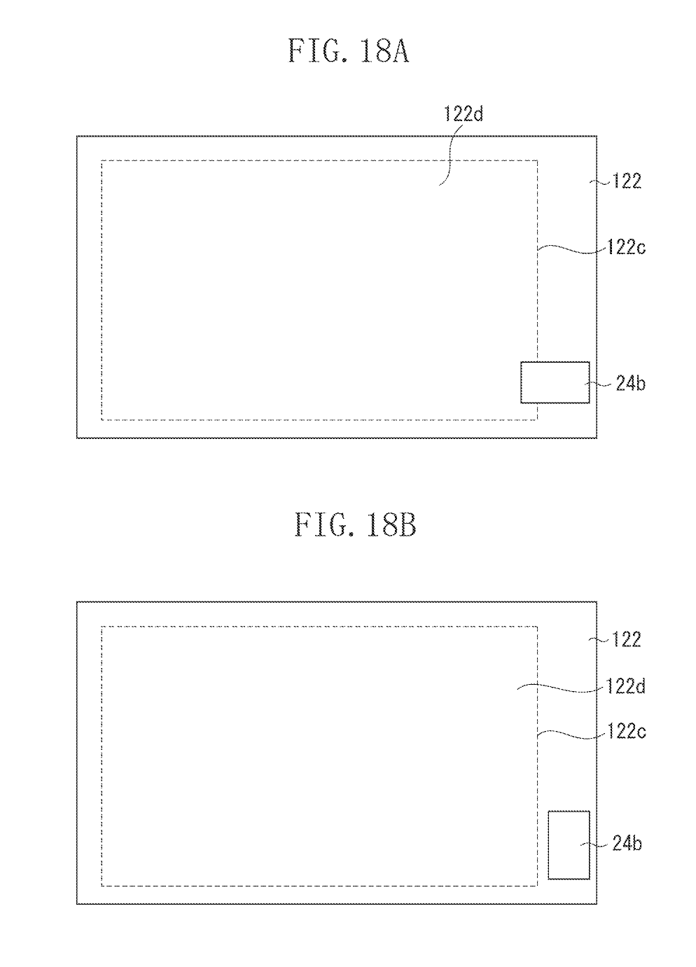

As described above, in this exemplary embodiment, the remaining toner amount detection portion 24a of the conductive sheet 24 is formed to have only a width necessary for the remaining toner amount detection in the toner storage container 23. Further, in the outward toner storage container 23, the contact portion 24b is exposed to the back side of the side contacting the toner. For example, the contact portion 24b can be provided as illustrated in FIGS. 18A and 18B. FIGS. 18 A and 18B are views from the back surface side, and in the drawings, the dotted lines indicate a portion where the first frame member and the second frame member are connected with a welding rib and a portion sealed through the development roller. The developer is stored inside the connected portions 122c. The contact portion 24b is disposed, as illustrated in FIG. 18B, outside of an area 122d surrounded by the connection portion formed by connecting the first frame member and the second frame member. As illustrated in FIG. 18A, a part of the contact portion 24b can be formed in the area. The contact portion 24b is provided at the end portion side in the longitudinal direction of the cover member in the vicinity of the developer bearing member. Similarly, FIGS. 21A and 21B illustrate the contact portion 24b provided in the area surrounded by the connection portion, which extends to the outside of the area. FIG. 21A illustrates the remaining toner amount detection portion 24a for storing the developer, and detecting a remaining amount using capacitance of the conductive sheet. FIG. 21B illustrates the back side of the frame member including the contact portion 24b of the conductive sheet. As will be understood from FIGS. 21A and 21B, the elongated end portion of the conductive sheet extends to wrap around the stirring member supporting portion for supporting the stirring member, extending in the frame member while extending in the direction intersecting with the longitudinal direction of the conductive sheet, and the conductive sheet appears as the contact portion 24b on the surface of the opposite side. The contact portion 24b of the conductive sheet extends in the same direction as the longitudinal direction of the conductive sheet.

With such an arrangement, the remaining toner amount contact 15 of the body side of the apparatus body A can be disposed at a further inner side in the longitudinal direction as compared to the toner storage portion 23a of the toner storage container. This contributes to reduction of the size of the apparatus body A.

### (The Developer Container)

In this exemplary embodiment, the developer container used in the development device has been mainly described. Alternatively, a developer container can be formed by the first frame member and the second frame member. In the developer container, the development roller serving as a developer bearing member can be omitted, and it is conceivable that the developer container is used, for example, as a cartridge for refill. Consequently, although the developer bearing member is used as the counter electrode of the conductive sheet in this exemplary embodiment, if the developer bearing member is not provided, another electrode for detecting capacitance is to be provided. To detect the capacitance generated between the conductive sheet and the electrode, in the case of the cartridge for refill, the conductive sheet and the electrode are to be provided near the opening through which the developer moves toward the refill destination.

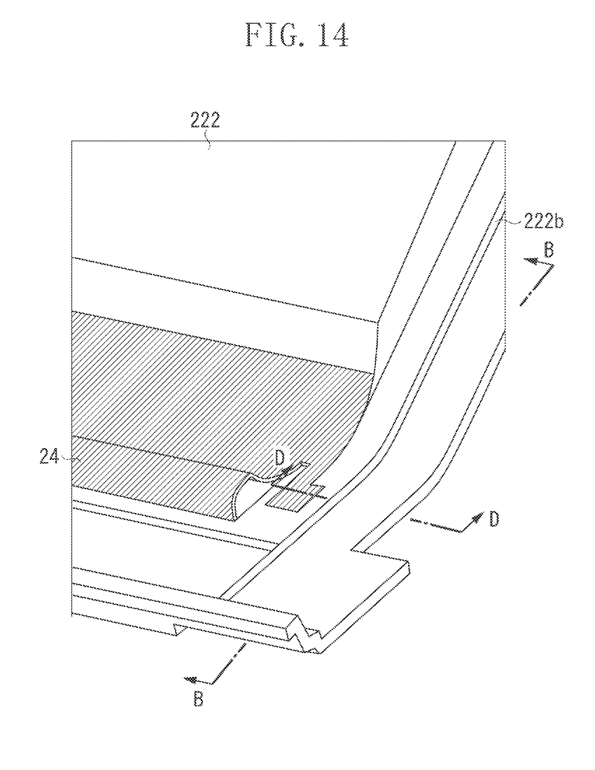

Hereinafter, with reference to FIGS. 14 to 17, the second exemplary embodiment of the present invention is described.

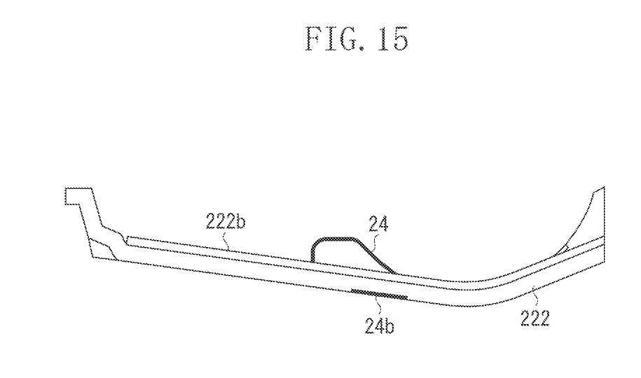

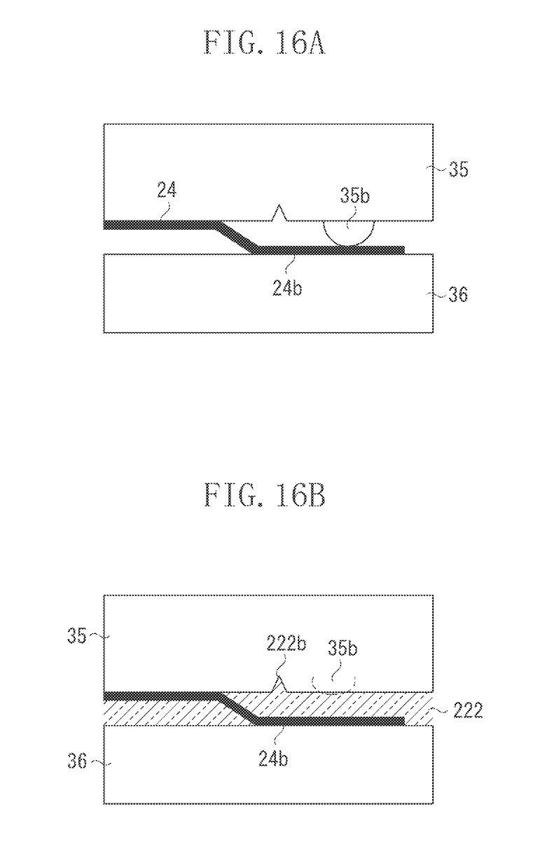

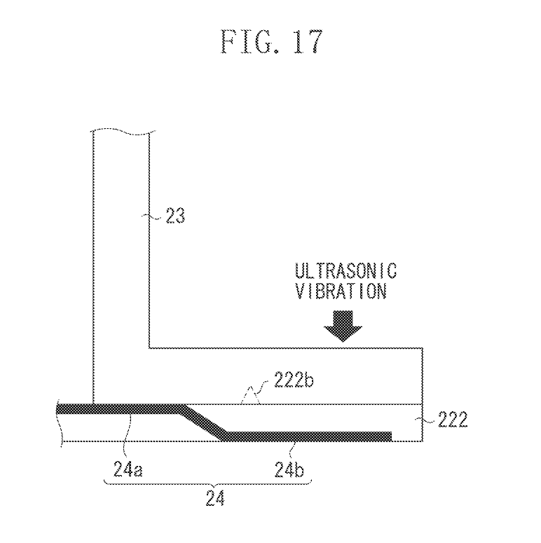

FIG. 14 is a partial perspective view illustrating a cover member 222 having the integrally formed conductive sheet 24 according to the exemplary embodiment. FIG. 15 is a partial cross-sectional view taken along the line B-B in FIG. 14. FIGS. 16A and 16B are schematic cross-sectional views illustrating a mold taken along the line D-D in FIG. 14. FIG. 17 is a cross-sectional view taken along the line D-D in FIG. 14, the view illustrating a state where the conductive sheet 24 is integrally formed to the cover member 222, and the toner storage container 23 is welded according to the exemplary embodiment.

In this exemplary embodiment, as illustrated in FIGS. 14 to 17, the contact portion 24b of the conductive sheet 24 is provided in the outside of a welding rib 222b of the cover member 222 to expose to the back of the side contacting the toner. The integral molding of the remaining toner amount detection portion 24a of the conductive sheet 24 to the cover member 222 is similar to that in the first exemplary embodiment.

With respect to the mold for forming the contact portion 24b of the conductive sheet 24 according to the exemplary embodiment, as illustrated in FIG. 16A, a retaining pin 35b that can retract is provided in the mold of the fixed side. When the mold is closed, by a spring force (not illustrated) provided in the retaining pin 35b, the contact portion 24b of the conductive sheet is fixed to the mold 36 of the movable side. When a resin is injected (FIG. 16B), the retaining pin 35b retracts by the resin pressure, and the molding is completed.

Similarly to the first exemplary embodiment, with respect to the mold-processed cover member 222, ultrasonic vibration is applied to the welding rib 222b to connect with the toner storage container 23. According to the exemplary embodiment, in the area outside the welding rib 222b, the conductive sheet 24 is disposed on the back side of the surface to be welded (the side contacting the toner in the cover member) to the toner storage container. Consequently, in the welding, the tearing of the conductive sheet 24 or increase in the electric resistance can be reduced.

In other words, in view of the component layout in the apparatus body A, even if the remaining toner amount 15 of the apparatus body side is to be disposed outside of the toner storage portion 23a, with the simple structure, both of the reliability of the contact and the toner sealing from the development device can be achieved.

In this exemplary embodiment, as the conductive sheet, the conductive sheet having conductivity at both sides of the conductive sheet 24 as shown in FIG. 8A, and the single-layer conductive sheet as shown in FIG. 8B are employed. In addition, even if the conductive sheet has the conductive layer only on one side as shown in FIG. 8C, as long as it achieves the remaining toner amount detection performance with its resistance value and the thickness, the conductive layer can be used by integrally molding to the cover member at the side contacting the remaining toner amount contact 15 on the body side.

As described in the exemplary embodiment, at a position inside the toner storage container in the longitudinal direction, the conductive sheet is integrally molded to be exposed to the back side of the cover member which the toner contacts. This structure can reduce the space of the image forming apparatus.

Further, at a position outside of the welding rib of the cover member, the conductive sheet is integrally molded to the cover member to be exposed on the back side of the cover member which the toner contacts. Accordingly, with the simple structure, both sealing of the toner from the development device and the reliability of the contact portion can be achieved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-146569 filed Jul. 12, 2013, and No. 2014-125611 filed Jun. 18, 2014 which are hereby incorporated by reference herein in their entirety.

What is claimed is:

1. A developer container comprising:
a conductive member including a resin, the conductive member being configured to detect a developer amount by using capacitance; and
a frame member configured to store the developer, the frame member having the conductive member,
wherein the conductive member is provided in a first side of the frame member contacting the developer and a second side of the frame member, the second side is the back of the first side, and the portion of the conductive member provided in the first side and the portion of the conductive member provided in the second side are connected with each other within the frame member.

2. The developer container according to claim 1, wherein the conductive member provided in the second side is a contact portion abutting on a contact of an apparatus body side of an image forming apparatus.

3. The developer container according to claim 1, wherein a surface area of the contact portion is smaller than a surface area of the portion of the conductive member provided in the first side.

4. The developer container according to claim 1, wherein the frame member includes a convex portion, and the conductive member is formed covering the convex portion.

5. The developer container according to claim 4, wherein the convex portion is provided in the first side, and the convex portion extends in the longitudinal direction of the portion of the conductive member.

6. The developer container according to claim 1, wherein the frame member includes a first frame member having the conductive member, and a second frame member configured to form a space capable of storing the developer by connecting with the first frame member.

7. The developer container according to claim 6, wherein the contact portion is provided inside the area surrounded by the connected portion formed by the first frame member and the second frame member connected with each other.

8. The developer container according to claim 1, wherein the conductive member and the first frame member are integrally molded.

9. The developer container according to claim 1, wherein the conductive member is extended to the inside of the frame member in a direction intersecting with the longitudinal direction of the portion provided in the first side to connect with the conductive member provided in the second side.

10. A developer container comprising:
a conductive member including a resin, the conductive member being configured to detect a developer amount by using capacitance; and
a frame member configured to store the developer, the frame member having the conductive member,
wherein the frame member includes a curved surface or a bent portion, and
the conductive member is provided on the curved surface or the bent portion.

11. The developer container according to claim 1, wherein the developer container includes an electrode for detecting a developer amount between the electrode and the conductive member.

12. The development device comprising:
a developer container according to claim 1, wherein the electrode is a developer bearing member configured to carry the developer.

13. The development device according to claim 12, wherein the curved surface or the bent portion is disposed between the developer bearing member and a stirring member configured to stir the developer.

14. The development device according to claim 12, wherein the development device includes a development chamber having the developer bearing member, and a storage chamber configured to store the developer, and the curved surface or the bent portion of the frame member are disposed in the storage chamber.

15. A process cartridge comprising:
a developer container according to claim 1; and
an image bearing member configured to carry a developer image formed by the developer.

16. An image forming apparatus comprising:
a developer container according to claim 1,
wherein the image forming apparatus forms an image on a recording medium using the developer.

17. A method for manufacturing the developer container according to claim 1, the method comprising:
holding the conductive member within a mold for forming the frame member;
deforming the conductive member such that a part of the conductive member is disposed on the first side and on the second side of the frame member; and
injecting the resin into the mold to form the frame member.

18. The method for manufacturing the developer container according to claim 17, wherein the conductive member is deformed by pressing the conductive member with a protrusion within the mold.
